(19) United States
(12) Patent Application Publication
(10) Pub. No.: US 2020/0101496 A1
(43) Pub. Date: Apr. 2, 2020

(54) SYSTEMS AND METHODS FOR ROBOTIC VEHICLE RETRIEVAL

(71) Applicant: Walmart Apollo, LLC, Bentonville, AR (US)

(72) Inventors: Jason Bellar, Bella Vista, AR (US); Jeremy L. Velten, Bella Vista, AR (US)

(21) Appl. No.: 16/585,786

(22) Filed: Sep. 27, 2019

Related U.S. Application Data
(60) Provisional application No. 62/738,058, filed on Sep. 28, 2018.

(51) Int. Cl. B07C 3/02; B65G 1/04; B65G 1/137; G06Q 10/08; G05D 1/02

(52) U.S. Cl. CPC B07C 3/02; B65G 1/0492; B07C 2301/0016; G06Q 10/087; G05D 1/0287; B65G 1/1373

(57) ABSTRACT

A robotic vehicle retrieval system that includes an automated sorting system and robotic vehicles configured to carry items in a facility is discussed. The automated sorting system is configured to instruct the robotic vehicles to retrieve items of a particular type at a pick-up location of the automated sorting system on demand and then retreat from the pick-up location as needed until each robotic vehicle is carrying a specified quantity of items of an item type. Upon reaching the specified quantity of items, the robotic vehicles deliver the items to designated locations in the facility.

### CROSS-REFERENCE TO RELATED APPLICATION

This application claims priority to U.S. Provisional Patent Application No. 62/738,058, filed on Sep. 28, 2018. The prior application is incorporated herein by reference in its entirety.

### BACKGROUND

Retailers and distributors may sort packages according to various factors (e.g., destination, size of package, storage requirements, etc.) to form groups of packages that are then delivered to their destinations.

### BRIEF DESCRIPTION OF THE DRAWINGS

The skilled artisan will understand that the drawings are primarily for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar or structurally similar elements).

The foregoing and other features and advantages provided by the present disclosure will be more fully understood from the following description of exemplary embodiments when read together with the accompanying drawings, in which:

FIG. 1 illustrates a network diagram depicting a system for implementing a robotic vehicle retrieval system, according to an example embodiment;

FIG. 2 is a flowchart illustrating an exemplary method employed by the robotic vehicle retrieval system, according to an example embodiment;

FIGS. 3A-3C illustrate views of a robotic vehicle used in the robotic vehicle retrieval system, according to an example embodiment;

FIG. 4 illustrates an overview of the robotic vehicle retrieval system, in accordance with an exemplary embodiment; and

FIG. 5 is a block diagram of an exemplary computing device that can be used to perform one or more steps of the methods provided by exemplary embodiments.

### DETAILED DESCRIPTION

Described herein are systems, methods, and computer readable media for a robotic vehicle retrieval system. In one exemplary embodiment, the system includes robotic vehicles configured to carry items from at least one item category. The system further includes an automated sorting system in communication with the robotic vehicles that is able to identify robotic vehicles that are available to retrieve items from the automated sorting system. The available robotic vehicles include at least a first robotic vehicle and a second robotic vehicle. The automated sorting system scans incoming items and identifies a first item of the incoming items. The first item is associated with a first category of the item categories. The automated sorting system instructs the first robotic vehicle to retrieve the first item at a pick-up location of the automated sorting system and then retreat from the pick-up location. The automated sorting system also identifies a second item of the incoming items. The second item is associated with a second category of the item categories. The automated sorting system instructs the second robotic vehicle to retrieve the second item at the pick-up location of the automated sorting system and then retreat from the pick-up location.

In the exemplary embodiment, the automated sorting system continues instructing the first robotic vehicle to retrieve identified incoming items associated with the first category at the pick-up location of the automated sorting system and then retreat from the pick-up location until the first robotic vehicle is carrying a first specified quantity of items. The automated sorting system also continues instructing the second robotic vehicle to retrieve identified incoming items associated with the second category at the pick-up location of the automated sorting system and then retreat from the pick-up location until the second robotic vehicle is carrying a second specified quantity of items. The automated sorting system instructs the first robotic vehicle to deliver the items associated with the first category to a first location associated with the first category based on the first robotic vehicle carrying the first specified quantity of items. The automated sorting system instructs the second robotic vehicle to deliver the items associated with the second category to a second location associated with the second category based on the second robotic vehicle carrying the second specified quantity of items. The first location and/or the second location may be a location located on a sales floor or an area of a facility used for storing items.

In some embodiments, a required number of available robotic devices are identified at least in part based on a shipping manifest itemizing all of the incoming items.

In some embodiments, the first robotic vehicle is configured to return to a transport mechanism of the automated sorting system to retrieve additional items after delivering the items associated with the first category to the first location.

In some embodiments, at least one of the first robotic vehicle or the second robotic vehicle includes a processor coupled to a memory, a communication interface configured to receive instructions from and send data to the automated sorting system, wheels powered by at least one battery, and at least two parallel arms configured to secure items between the parallel arms. The at least one of the first robotic vehicle or the second robotic vehicle further includes a plate suspended between the parallel arms. The plate is configured to hold items and be raised and lowered to a floor. A pusher located above the plate is configured to push the items off the plate when the plate is lowered to the floor. In some embodiments, the end of the plate is tapered to more easily slide the items off the plate when the plate is lowered to the floor.

In some embodiments, the automated sorting system further includes articulated arms configured to enable the picking of the identified items from a transport mechanism of the automated sorting system, such as but not limited to a conveyor belt or series of rollers, and deposit the identified items on the at least one of the first robotic vehicle and the second robotic vehicle.

In some embodiments, the automated sorting system instructs the first robotic vehicle to retrieve the items associated with the first category from the first location. The automated sorting system then instructs the first robotic vehicle to deliver the items associated with the first category to a new location on a sales floor associated with the first category.

In some embodiments, the first robotic vehicle includes a processor and memory. In such an embodiment, the first robotic vehicle delivers the items associated with the first category to an available site within an area of a facility used for storing items. The first robotic vehicle stores location coordinates associated with the site within the memory. Subsequently, the first robotic vehicle receives instructions to deliver the items associated with the first category to a location located on a sales floor and retrieves the location coordinates associated with the items associated with the first category from the memory. The first robotic vehicle retrieves the items associated with the first category from the site in the facility based on the location coordinates. The first robotic vehicle then delivers the items associated with the first category to the location located on the sales floor.

In some embodiments, the automated sorting system determines the first location based on a calculated demand of the items associated with the first category.

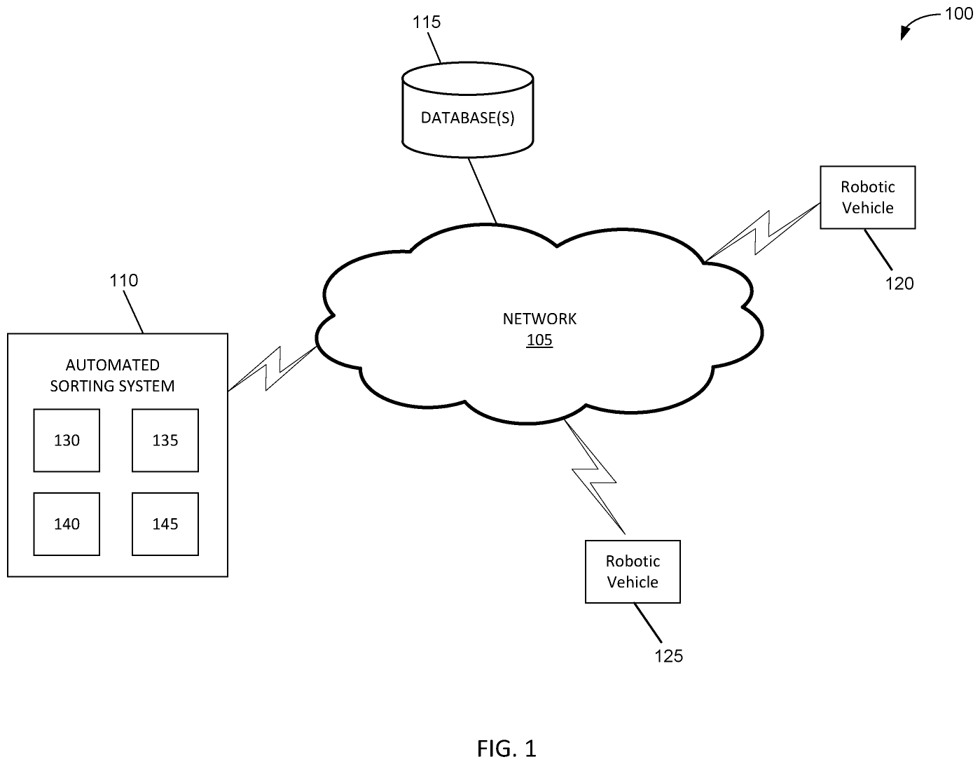

FIG. 1 illustrates a network diagram depicting a system 100 for implementing the robotic vehicle retrieval system, according to an example embodiment. The system 100 can include a network 105, an automated sorting system 110, a database(s) 115, and at least two robotic vehicles 120, 125. Each of the automated sorting system 110, the database(s) 115, and the robotic vehicles 120, 125 is in communication with the network 505 via a wired or wireless connection.

In an example embodiment, one or more portions of network 105 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The automated sorting system 110 may include one or more processors and memory and be implemented using one or more modules. The automated sorting system 110 may also include one or more scanners for identifying incoming items and may include one or more transport mechanisms such as but not limited to conveyor belts and/or a series or rollers for physically transporting items to different collection areas. The modules may include an input data module 130, a category determination module 135, a retrieval module 140, and an instruction data module 145. The modules may include various circuits, circuitry and one or more software components, programs, applications, or other units of code base or instructions configured to be executed by one or more processors. It should be understood that modules 130, 135, 140, and 145 may be implemented as fewer or more modules than illustrated.

The input data module 130 may be a software or hardware-implemented module configured to receive and identify items to be received by robotic vehicles. The input data module 130 may be in communication with a scanning device configured to scan incoming items. For example, the scanning device may scan RFID tags and/or barcodes affixed to the items. In an exemplary illustration, the input data module 130 may identify a first item of the incoming items. In one embodiment, the scanning device is physically integrated into the automated sorting system. In another embodiment, the scanning device is a separate scanner communicating with the automated sorting system.

The category determination module 135 may be a software or hardware-implemented module configured to associate identified incoming items with item categories. In the exemplary illustration, the category determination module 135 may associate the first item with a first item category based on a comparison of scanned data with item category data stored in one or more databases that are communicatively coupled to the automated sorting system.

The retrieval module 140 may be a software or hardware-implemented module configured to identify available robotic vehicles and instruct them to retrieve items at a pick-up location/collection area of the automated sorting system. In one embodiment, the retrieval module may be continually or periodically track the location and status of the robotic vehicles to determine which vehicles may be used to retrieve items. For example, the retrieval module may communicate with the robotic vehicles to determine a location, an available power level, the amount of weight the vehicles are carrying and/or the amount of available space on the vehicle to determine whether the weight, space, power level and/or location satisfy pre-determined thresholds thereby making them available to retrieve additional items. For example, the vehicle may need to be within a certain distance of the automated sorting system, with more than a specified power level, while also meeting weight and space thresholds in order to be determined as “available” by the retrieval module. In one non-limiting example, the pickup location may be the end of a conveyor belt or series of rollers that has been used to transport the item following scanning.

Once the available vehicles have been identified by the retrieval module 140, in an embodiment, the retrieval module 140 may instruct a first robotic vehicle to retrieve the first item at the pick-up location of the automated sorting system and then retreat from the pick-up location. As additional items of the first type of item are identified by the automated sorting system, the retrieval module 140 continues instructing the first robotic vehicle to retrieve the identified incoming items associated with the first category at the pick-up location of the automated sorting system and then retreat from the pick-up location until the first robotic vehicle is carrying a first specified quantity of items. It will be appreciated that the quantity threshold may be chosen based on the corresponding weight and size of the items associated with that quantity. Similarly, the retrieval module 140 may instruct a second robotic vehicle to retrieve the second type of item at the pick-up location of the automated sorting system and then retreat from the pick-up location. As additional items of the second type of item are identified by the automated sorting system, the retrieval module 140 continues instructing the second robotic vehicle to retrieve the identified incoming items associated with the second category at the pick-up location of the automated sorting system and then retreat from the pick-up location until the second robotic vehicle is carrying a second specified quantity of items.

The instruction data module 145 instructs the robotic vehicles to deliver the items to locations in a facility associated with the respective category. In the exemplary illustration, the instruction data module 145 instructs the first robotic vehicle to deliver the items associated with the first category to a first location in a facility associated with the first category based on the first robotic vehicle carrying the first specified quantity of items.

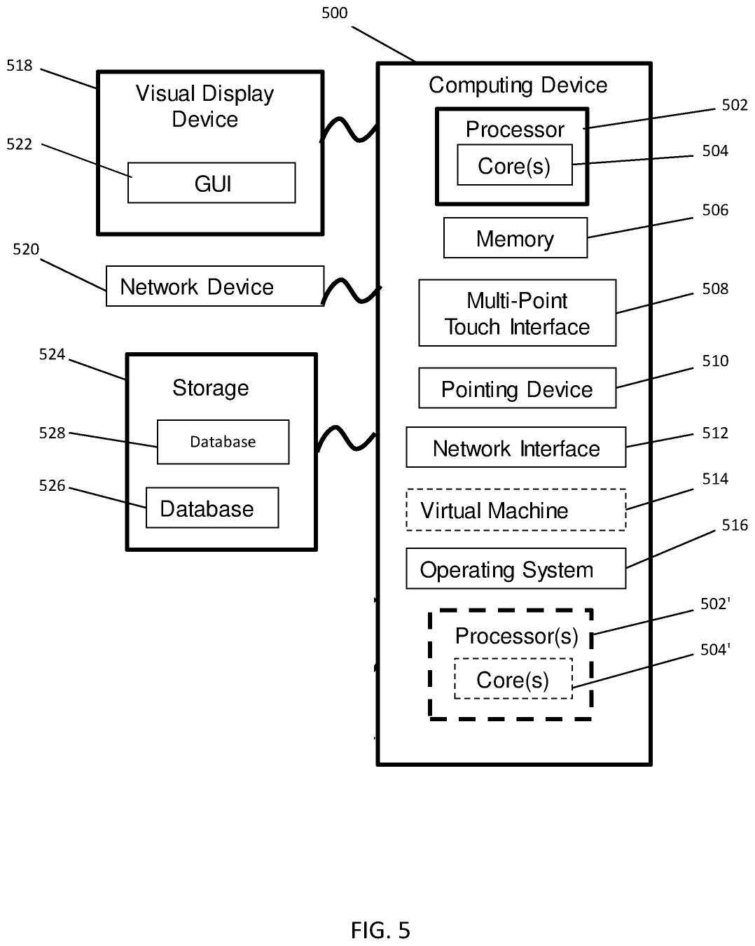

The automated sorting system 110 and robotic vehicles can include one or more components of computing device 500 of FIG. 5. Database(s) 115 include one or more storage devices for storing data and/or instructions (or code) for use by automated sorting system 110, and/or robotic vehicles 120, 125. Database(s) 115 and automated sorting system 110 may be located at one or more geographically distributed locations from each other. Alternatively, database(s) 115 may be included within automated sorting system 110.

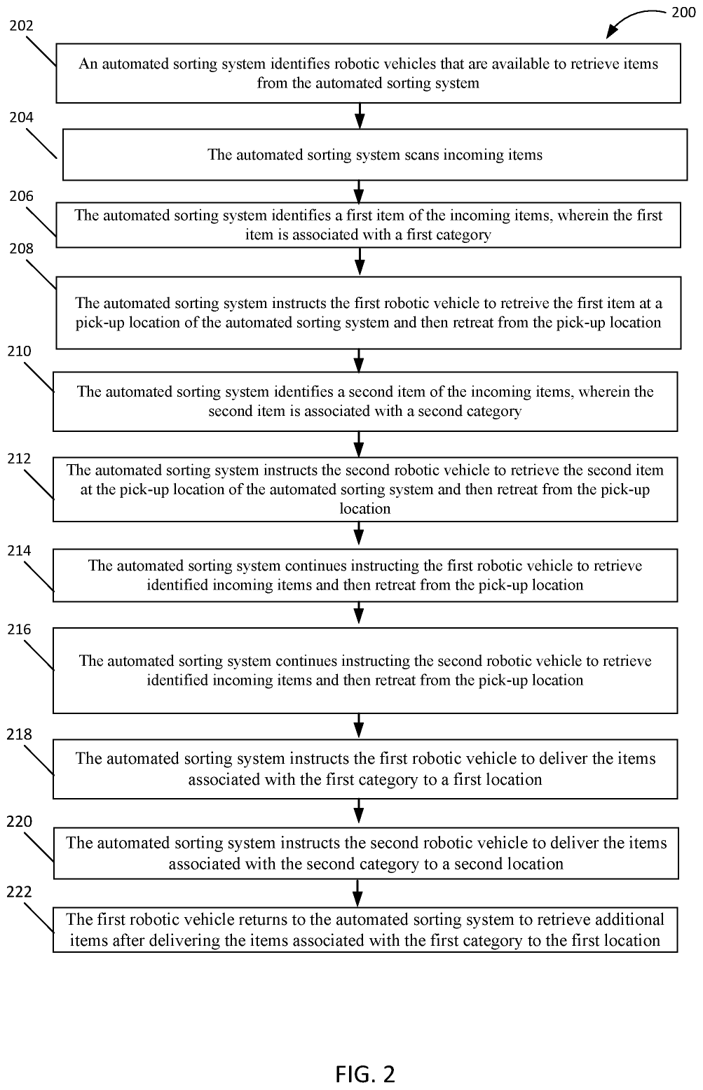

FIG. 2 is a flowchart illustrating an exemplary method 200 for controlling robotic vehicles, according to an example embodiment. The method 200 may be performed using or one or more modules of system 100 described above.

At block 202, an automated sorting system identifies robotic vehicles that are available to retrieve items from the automated sorting system. The available robotic vehicles including at least a first robotic vehicle and a second robotic vehicle. The robotic vehicles are configured to carry items from at least one item category.

At block 204, the automated sorting system scans incoming items.

At block 206, the automated sorting system identifies a first item of the incoming items, wherein the first item is associated with a first category.

At block 208, the automated sorting system instructs the first robotic vehicle to retrieve the first item at a pick-up location of the automated sorting system and then retreat from the pick-up location.

At block 210, the automated sorting system identifies a second item of the incoming items, wherein the second item is associated with a second category.

At block 212, the automated sorting system instructs the second robotic vehicle to retrieve the second item at the pick-up location of the automated sorting system and then retreat from the pick-up location.

In one embodiment, the automated sorting system may include multiple transport mechanisms such as conveyor belts and/or series of rollers used to separate categories of items and the pick-up locations may be a conveyor belt or roller series dedicated to that type of item. In other embodiments the first and second pick-up locations may not be dedicated to particular categories of items and/or may be the same pick-up location (such as when the automated sorting system includes only a single conveyor belt/roller series/transport mechanism).

At block 214, the automated sorting system continues instructing the first robotic vehicle to retrieve identified incoming items associated with the first category at the pick-up location of the automated sorting system and then retreat from the pick-up location until the first robotic vehicle is carrying a first specified quantity of items.

At block 216, the automated sorting system continues instructing the second robotic vehicle to retrieve identified incoming items associated with the second category at the pick-up location of the automated sorting system and then retreat from the pick-up location until the second robotic vehicle is carrying a second specified quantity of items.

At block 218, the automated sorting system instructs the first robotic vehicle to deliver the items associated with the first category to a first location in the facility that is associated with the first category based on the first robotic vehicle carrying the first specified quantity of items.

At block 220, the automated sorting system instructs the second robotic vehicle to deliver the items associated with the second category to a second location in the facility that is associated with the second category based on the second robotic vehicle carrying the second specified quantity of items.

At block 222, the first robotic vehicle returns to the automated sorting system to retrieve additional items after delivering the items associated with the first category to the first location in response to a command from the retrieval module.

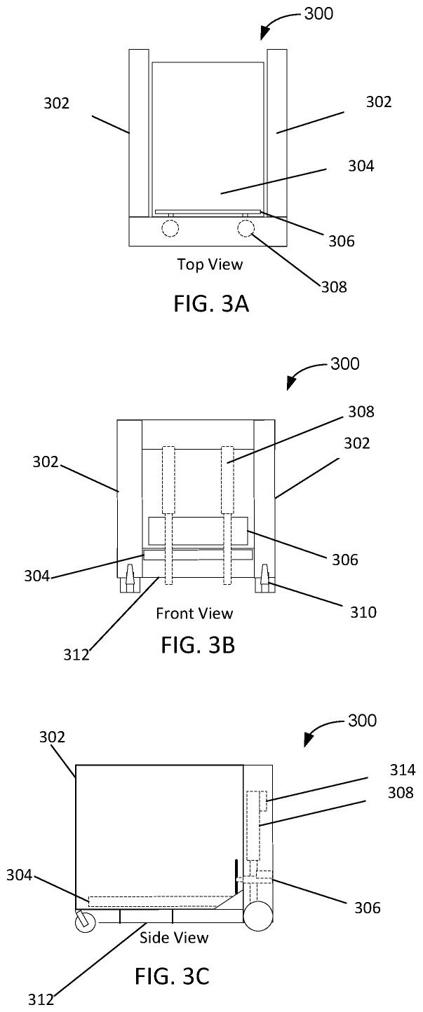

FIGS. 3A-3C illustrate views of a robotic vehicle 300, in accordance with an exemplary embodiment.

FIG. 3A illustrates a top view of the robotic vehicle 300 in an exemplary embodiment. The robotic vehicle 300 includes two parallel arms 302 configured to secure items between the parallel arms 302. The robotic vehicle 300 further includes a plate 304 suspended between the parallel arms 302. The plate 304 is configured to hold items and to be raised and lowered to a floor.

The robotic vehicle 300 includes a pusher 306 located above the plate 304 configured to push the items off the plate 304 when the plate 304 is lowered to the floor. The robotic vehicle 300 further includes at least one cylinder 308 configured to raise and lower the plate 304.

FIG. 3B illustrates a front view of the robotic vehicle 300 in an exemplary embodiment. The robotic vehicle 300 includes a pusher 306 located above the plate 304 configured to push the items off the plate 304 when the plate 304 is lowered to the floor. The robotic vehicle 300 further includes at least one cylinder 308 configured to raise and lower the plate 304. The robotic vehicle 300 further includes wheels 310 powered by at least one battery 312.

FIG. 3C illustrates a side view of the robotic vehicle 300 in an exemplary embodiment. The robotic vehicle 300 includes the pusher 306 located above the plate 304 configured to push the items off the plate 304 when the plate 304 is lowered to the floor. The robotic vehicle 300 further includes the cylinders 308 configured to raise and lower the plate 304. The robotic vehicle 300 further includes wheels 310 powered by at least one battery 312.

In some embodiments, the robotic vehicle 300 includes a computing system 314. The computing system 314 includes a processor coupled to a memory and a communication interface configured to receive instructions from, and send data to, the automated sorting system.

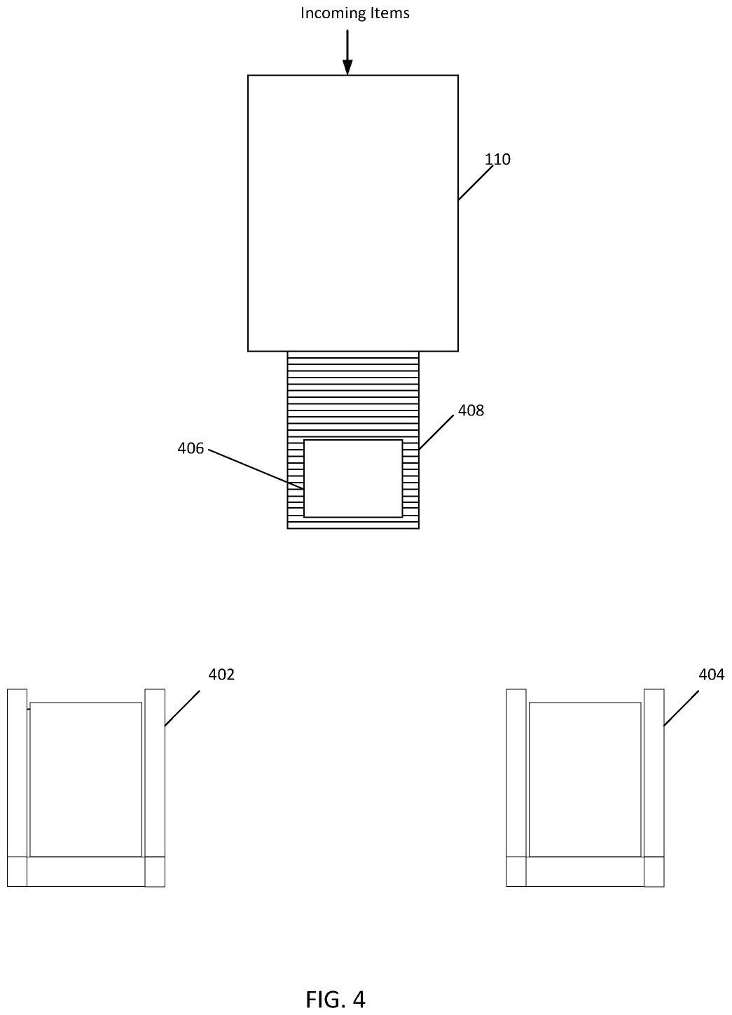

FIG. 4 illustrates the robotic vehicle retrieval system, in accordance with an exemplary embodiment. Robotic vehicles 402, 404 are configured to carry items from one or more item categories. An automated sorting system 110 is in communication with the robotic vehicles 402, 404. The automated sorting system 110 identifies robotic vehicles 402, 404 from a group of robotic vehicles present in the facility to determine those robotic vehicles that are available to retrieve items from the automated sorting system 110.

The automated sorting system 110 scans incoming items and identifies a first item 406 of the incoming items. For example, the items can be moving on a transport mechanism 408 such as but not limited to a conveyor belt or series of rollers. The first item 406 is associated with a first category. The automated sorting system instructs the first robotic vehicle 402 to retrieve the first item 406 at a pick-up location of the automated sorting system 110 and then retreat from the pick-up location. For example, the pick-up location may be the end of the transport mechanism 408. The automated sorting system 110 identifies a second item of the incoming items, wherein the second item is associated with a second category. The automated sorting system 110 instructs the second robotic vehicle 404 to retrieve the second item at the pick-up location of the automated sorting system 110 and then retreat from the pick-up location. By instructing the first robotic vehicle 402 and second robotic vehicle 404 to retreat after retrieval, the automated sorting system 110 is able to arrange a clear path to the pick-up location for additional robotic vehicles. It should be appreciated that although two robotic vehicles are discussed and illustrated herein, a larger number of robotic vehicles may also be controlled by the automated sorting system 110 within the scope of the present invention to retrieve items processed by the automated sorting system.

The automated sorting system 110 continues instructing the first robotic vehicle 402 to retrieve identified incoming items associated with the first category at the pick-up location of the automated sorting system 110 and then retreat from the pick-up location until the first robotic vehicle 402 is carrying a first specified quantity of items. The automated sorting system 110 continue instructing the second robotic vehicle 404 to retrieve identified incoming items associated with the second category at the pick-up location of the automated sorting system 110 and then retreat from the pick-up location until the second robotic vehicle 404 is carrying a second specified quantity of items. The first and second specified quantity of items may be a pre-determined quantity of items based on the physical carrying capacity and/or power status of the robotic vehicle. Alternatively, in one embodiment, the first and second specified quantity may be a dynamically determined quantity based on a power status of the robotic vehicle and the weight of items carried by the vehicle.

The automated sorting system 110 instructs the first robotic vehicle 402 to deliver the items associated with the first category to a first location in the facility that is associated with the first category based on the first robotic vehicle 402 carrying the first specified quantity of items. The automated sorting system 110 also instructs the second robotic vehicle 404 to deliver the items associated with the second category to a second location in the facility that is associated with the second category based on the second robotic vehicle 404 carrying the second specified quantity of items. As non-limiting examples, the first location and the second location may be locations in a storage section of the facility or may be locations on a sales floor of the facility.

FIG. 5 is a block diagram of an exemplary computing device 500 that can be used in one or more exemplary embodiments. For example, computing device 500 may be, but is not limited to the automated sorting system 110 and robotic vehicles 120 and 125 as described in FIG. 1. The computing device 500 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 506 included in the computing device 500 can store computer-readable and computer-executable instructions or software for implementing exemplary embodiments. The computing device 500 also includes processor 502 and associated core 504, and optionally, one or more additional processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ can each be a single core processor or multiple core (604 and 504′) processor. The computing device 500 also includes a graphics-processing unit (GPU) 505. In some embodiments, the computing device 500 includes multiple GPUs.

Virtualization can be employed in the computing device 500 so that infrastructure and resources in the computing device can be shared dynamically. A virtual machine 514 can be provided to handle a process running on multiple processors so that the process appears to be using only one computing resource rather than multiple computing resources. Multiple virtual machines can also be used with one processor.

Memory 506 can include a computer system memory or random access memory, such as DRAM, SRAM, EDO RAM, and the like. Memory 506 can include other types of memory as well, or combinations thereof. A user can interact with the computing device 500 through a visual display device 518, such as a touch screen display or computer monitor, which can display one or more graphical user interfaces 522. The visual display device 518 can also display other aspects, elements and/or information or data associated with exemplary embodiments. The computing device 500 can include other I/O devices for receiving input from a user, for example, a keyboard or any suitable multi-point touch interface 508, a pointing device 510 (e.g., a pen, stylus, mouse, or trackpad). The keyboard 508 and the pointing device 510 can be coupled to the visual display device 518. The computing device 500 can include other suitable conventional I/O peripherals.

The computing device 500 can also include one or more storage devices 524, such as a hard-drive, CD-ROM, or other computer readable media, for storing data and computer-readable instructions and/or software, such as one or more modules of the system 100 shown in FIG. 1 that implements exemplary embodiments of the system as described herein, or portions thereof, which can be executed to generate a graphical user interface 522 on display 518. Exemplary storage device 524 can also store one or more databases for storing any suitable information required to implement exemplary embodiments. The databases can be updated by a user or automatically at any suitable time to add, delete or update one or more items in the databases. Exemplary storage device 524 can store one or more databases 526 for storing upcoming items and/or one or more databases 528 for storing robotic vehicles, and other data/information used to implement exemplary embodiments of the systems and methods described herein.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 can include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 500 can run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 516 can be run in native mode or emulated mode. In an exemplary embodiment, the operating system 516 can be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other embodiments, functions and advantages are also within the scope of the present disclosure.

What is claimed is:

1. A robotic vehicle retrieval system comprising:
a plurality of robotic vehicles configured to carry a plurality of items from at least one of a plurality of item categories; and
an automated sorting system in communication with the plurality of robotic vehicles, the automated sorting system including one or more transport mechanisms for moving the plurality of items and configured to:
identify robotic vehicles from the plurality of robotic vehicles that are available to retrieve items from the automated sorting system, the available robotic vehicles including at least a first robotic vehicle and a second robotic vehicle;
scan incoming items of the plurality of items;
identify a first item of the incoming items, wherein the first item is associated with a first category of the plurality of item categories;
instruct the first robotic vehicle of the plurality of robotic vehicles to retrieve the first item at a pick-up location of the automated sorting system and then retreat from the pick-up location;
identify a second item of the incoming items, wherein the second item is associated with a second category of the plurality of item categories;
instruct the second robotic vehicle of the plurality of robotic vehicles to retrieve the second item at the pick-up location of the automated sorting system and then retreat from the pick-up location;
continue instructing the first robotic vehicle to retrieve identified incoming items associated with the first category at the pick-up location of the automated sorting system and then retreat from the pick-up location until the first robotic vehicle is carrying a first specified quantity of items;
continue instructing the second robotic vehicle to retrieve identified incoming items associated with the second category at the pick-up location of the automated sorting system and then retreat from the pick-up location until the second robotic vehicle is carrying a second specified quantity of items;
instruct the first robotic vehicle to deliver the items associated with the first category to a first location associated with the first category based on the first robotic vehicle carrying the first specified quantity of items; and
instruct the second robotic vehicle to deliver the items associated with the second category to a second location associated with the second category based on the second robotic vehicle carrying the second specified quantity of items.

2. The system of claim 1, wherein a required number of available robotic devices are identified at least in part based on a shipping manifest itemizing all of the incoming items.

3. The system of claim 1, wherein the first robotic vehicle is configured to return to the automated sorting system to retrieve additional items after delivering the items associated with the first category to the first location.

4. The system of claim 1, wherein at least one of the first robotic vehicle and the second robotic vehicle comprises:
a processor coupled to a memory;
a communication interface configured to receive instructions from, and send data to, the automated sorting system;
a plurality of wheels powered by at least one battery;
at least two parallel arms configured to secure items of the plurality of items between the parallel arms;
a plate suspended between the parallel arms, the plate configured to hold items of the plurality of items and to be raised and lowered to a floor; and
a pusher located above the plate configured to push the items off the plate when the plate is lowered to the floor.

5. The system of claim 1, wherein the automated sorting system further comprises:
articulated arms configured to enable the picking of the identified items from a transport mechanism and their deposit on at least one of the first robotic vehicle and the second robotic vehicle.

6. The system of claim 1, wherein the first location is a location located on a sales floor.

7. The system of claim 1, wherein the first location is an area of a facility used for storing items.

8. The system of claim 7, wherein the automated sorting system is further configured to:
instruct the first robotic vehicle to retrieve the items associated with the first category from the first location; and
instruct the first robotic vehicle to deliver the items associated with the first category to a new location on a sales floor associated with the first category.

9. The system of claim 7, wherein the first robotic vehicle includes a memory, the first robotic vehicle configured to:
deliver the items associated with the first category to an available site within the area of a facility used for storing items;
store location coordinates associated with the site within the memory;
receive instructions to deliver the items associated with the first category to a location located on a sales floor;
retrieve the location coordinates associated with the items associated with the first category from the memory;
retrieve the items associated with the first category from the site based on the location coordinates; and
deliver the items associated with the first category to the location located on the sales floor.

10. The system of claim 1, wherein the automated sorting system is further configured to determine the first location based on a calculated demand of the items associated with the first category.

11. A method for controlling robotic vehicles comprising:
identifying, via an automated sorting system in communication with a plurality of robotic vehicles configured to carry a plurality of items from at least one of a plurality of item categories, robotic vehicles from the plurality of robotic vehicles that are available to retrieve items from the automated sorting system, the available robotic vehicles including at least a first robotic vehicle and a second robotic vehicle;
scanning, via the automated sorting system, incoming items of the plurality of items;
identifying, via the automated sorting system, a first item of the incoming items, wherein the first item is associated with a first category of the plurality of item categories;
instructing, via the automated sorting system, the first robotic vehicle of the plurality of robotic vehicles to retrieve the first item at a pick-up location of the automated sorting system and then retreat from the pick-up location;
identifying, via the automated sorting system, a second item of the incoming items, wherein the second item is associated with a second category of the plurality of item categories;
instructing, via the automated sorting system, the second robotic vehicle of the plurality of robotic vehicles to retrieve the second item at the pick-up location of the automated sorting system and then retreat from the pick-up location;
continuing, via the automated sorting system, instructing the first robotic vehicle to retrieve identified incoming items associated with the first category at the pick-up location of the automated sorting system and then retreat from the pick-up location until the first robotic vehicle is carrying a first specified quantity of items;
continuing, via the automated sorting system, instructing the second robotic vehicle to retrieve identified incoming items associated with the second category at the pick-up location of the automated sorting system and then retreat from the pick-up location until the second robotic vehicle is carrying a second specified quantity of items;
instructing, via the automated sorting system, the first robotic vehicle to deliver the items associated with the first category to a first location associated with the first category based on the first robotic vehicle carrying the first specified quantity of items; and
instructing, via the automated sorting system, the second robotic vehicle to deliver the items associated with the second category to a second location associated with the second category based on the second robotic vehicle carrying the second specified quantity of items.

12. The method of claim 11, wherein a required number of available robotic devices are identified at least in part based on a shipping manifest itemizing all of the incoming items.

13. The method of claim 11, further comprising the first robotic vehicle returning to the automated sorting system to retrieve additional items after delivering the items associated with the first category to the first location.

14. The method of claim 11, further comprising building at least one of the first robotic vehicle and the second robotic vehicle comprising:
a processor coupled to a memory;
a communication interface configured to receive instructions from, and send data to, the automated sorting system;
a plurality of wheels powered by at least one battery;
at least two parallel arms configured to secure items of the plurality of items between the parallel arms;
a plate suspended between the parallel arms, the plate configured to hold items of the plurality of items and to be raised and lowered to a floor; and
a pusher located above the plate configured to push the items off the plate when the plate is lowered to the floor.

15. The method of claim 11, wherein the automated sorting system further comprises articulated arms, the method further comprising using the articulated arms to pick the identified items from a transport mechanism and deposit the identified items on at least one of the first robotic vehicle and the second robotic vehicle.

16. The method of claim 11, wherein the first location is a location located on a sales floor.

17. The method of claim 11, wherein the first location is an area of a facility used for storing items.

18. The method of claim 17, further comprising:
instructing, via the automated sorting system, the first robotic vehicle to retrieve the items associated with the first category from the first location; and
instructing, via the automated sorting system, the first robotic vehicle to deliver the items associated with the first category to a new location on a sales floor associated with the first category.

19. The method of claim 17, wherein the first robotic vehicle includes a memory, the method further comprising:
delivering, via the first robotic vehicle, the items associated with the first category to an available site within the area of the facility used for storing items;
storing, via the first robotic vehicle, location coordinates associated with the site within the memory;
receiving, via the first robotic vehicle, instructions to deliver the items associated with the first category to a location located on a sales floor;
retrieving, via the first robotic vehicle, the location coordinates associated with the items associated with the first category from the memory;
retrieving, via the first robotic vehicle, the items associated with the first category from the site based on the location coordinates; and
delivering, via the first robotic vehicle, the items associated with the first category to the location located on the sales floor.

20. The method of claim 11, further comprising determining, via the automated sorting system, the first location based on a calculated demand of the items associated with the first category.
